(19) United States
(12) Patent Application Publication
(10) Pub. No.: US 2014/0006832 A1
(43) Pub. Date: Jan. 2, 2014

(54) POWER SUPPLY CIRCUIT AND HARD DISK BACKPLANE USING SAME

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: KANG WU, Shenzhen (CN); BO TIAN, Shenzhen (CN)

(21) Appl. No.: 13/922,201

(22) Filed: Jun. 19, 2013

(30) Foreign Application Priority Data
Jun. 28, 2012 (CN) 2012102178160

(51) Int. Cl. G06F 1/32

(52) U.S. Cl. CPC G06F 1/3268
USPC 713/324

(57) ABSTRACT

A power supply circuit includes a first power input terminal, a second power input terminal, a first switch circuit, and a first switch controller. The first and second power input terminals are configured to receive a first voltage and output the first voltage to supply a first hard disk group and a second hard disk group. The first switch circuit is coupled between the first power input terminal and the second power input terminal. The first switch controller switches on or switches off the first switch circuit. When the first switch circuit is switched on, the first power input terminal is connected to the second power input terminal. When the first switch circuit is switched off, the first power input terminal is disconnected from the second power input terminal.

### BACKGROUND

1. Technical Field

The present disclosure relates to power supply technologies, and more particularly to a power supply circuit and a hard disk backplane using the same.

2. Description of Related Art

Servers are usually placed in an enclosure. When one server is placed in the enclosure, all of the hard disk drivers are supplied by the server. When two servers are placed in the enclosure, the hard disk drivers are divided into two groups, and each group of the hard disk drivers are supplied by one of the servers. In the above two conditions, because power supply circuits of a hard disk backplane are different, a single hard disk backplane cannot be used in the above two conditions.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a block diagram of a power supply circuit according to an exemplary embodiment of present disclosure.

FIG. 2 is a circuit diagram of the power supply circuit powering the hard disk driver groups of FIG. 1.

FIG. 3 is a circuit diagram of a hard disk backplane powering the hard disk groups.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

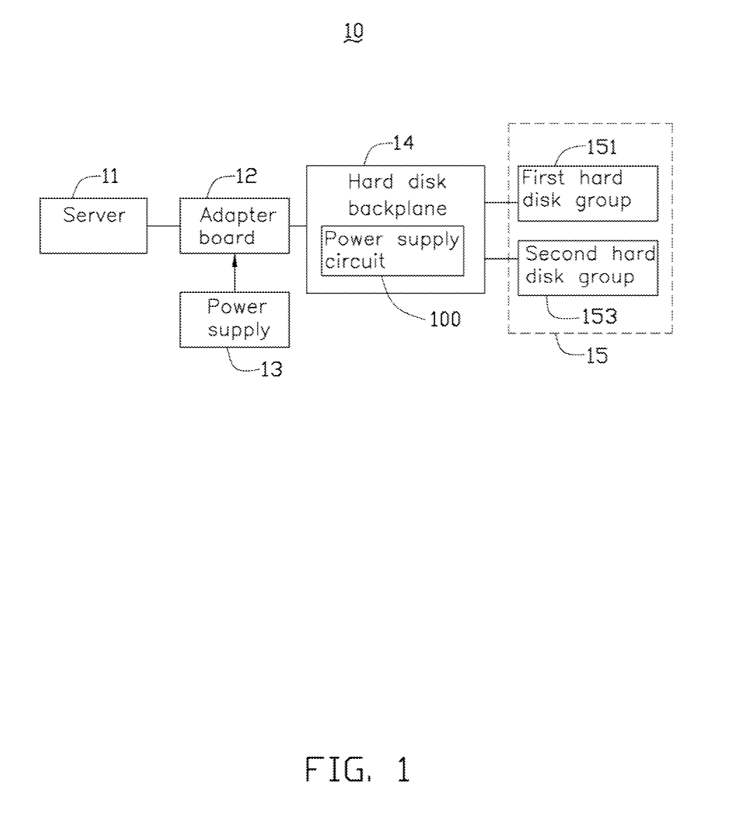

FIG. 1 is a block diagram of a power supply circuit 100 according to an exemplary embodiment of present disclosure. A service system 10 includes at least one server 11, an adapter board 12, a power supply 13, a hard disk backplane 14 and at least one hard disk driver (HDD) group 15. In this example, the service system 10 may be a server drives a driver for hard disk though a backplane. The hard disk driver group is a group includes at least one driver for hard disk.

The at least one server 11, the adapter board 12, the power supply 13, the hard disk backplane 14 and the at least one hard disk driver group 15 are placed in an enclosure of the service system 10. The server 11 is electronically coupled to the hard disk driver group 15 via the adapter board 12 and the hard disk backplane 14 sequentially. The server 11 is configured to control the hard disk driver group 15. The adapter board 12 may be an extension board or a bridge board. An assisting circuit for assisting the server 11 to control the hard disk driver group 15 is placed on the adapter board 12. The power supply 13 is electronically coupled to the adapter board 12. The power supply 13 is configured to supply the server 11 and the hard disk backplane 14 via the adapter board 12 with power. The power supply circuit 100 is placed on the hard disk backplane 14. The power supply circuit 100 receives a voltage from the power supply 13 via the adapter board 12 and supplies power to hard disk drivers of the hard disk driver group 15.

The server 11 may be connected the adapter board 12 via a connector inserted on the adapter board 12. The adapter board 12 is electronically coupled to the hard disk backplane 14 by using connectors and cables. The hard disk driver group 15 is electronically coupled to the hard disk backplane 14 via a connector inserted in the hard disk backplane 14. The hard disk driver group 15 may include several hard disks, and in one embodiment, the number of the hard disks in the hard disk driver group 15 is three.

In the embodiment, the service system 10 includes two hard disk driver groups, that is, the hard disk driver group 15 includes a first hard disk group 151 and a second hard disk group 153. Each of the first hard disk group 151 and the second hard disk group 153 includes three hard disks. Two servers 11 are placed in the enclosure of the service system 10, that is, the two servers 11 are connected to the adapter board 12 via a connector inserted in the adapter board 12. The first hard disk group 151 and the second hard disk group 153 are controlled by two servers 11 respectively. In another embodiment, if only one server 11 is placed in the enclosure of the service system 10, both of the first hard disk group 151 and the second hard disk group 153 are controlled by the single server 11.

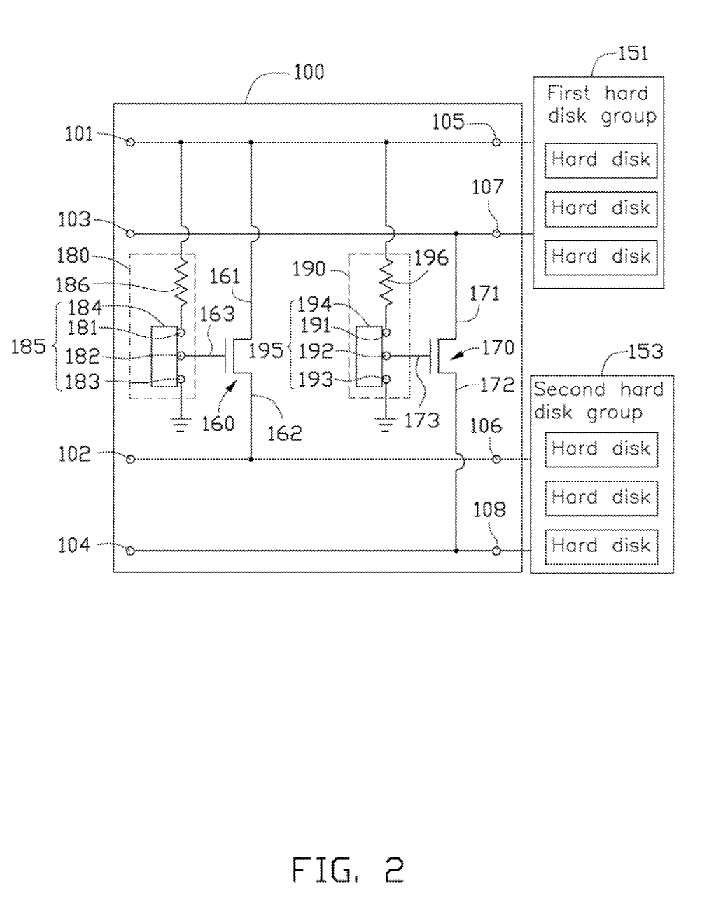

FIG. 2 is a circuit diagram of the power supply circuit 100 for hard disk driver powering the hard disk drivers groups of FIG. 1. The power supply circuit 100 includes a first power input terminal 101, a second power input terminal 102, a third power input terminal 103, a fourth power input terminal 104, a first power output terminal 105, a second power output terminal 106, a third power output terminal 107, a fourth power output terminal 108, a first switch circuit 160, a second switch circuit 170, a first switch controller 180 and a second switch controller 190.

The first power input terminal 101 and the second power input terminal 102 receive a first voltage from the adapter 12 and output the first voltage to supply the first hard disk group 151 and the second hard disk group 153. In the embodiment, the first power input terminal 101, the second power input terminal 102, the third power input terminal 103 and the fourth power input terminal 104 are connected to the adapter board 12 via connecters and cables.

In detail, the first voltage is received by the first power input terminal 101, and is output from the first power output terminal 105 for supplying the first hard disk group 151. The first voltage is also received by the second power input terminal 102, and is output from the second power output terminal 106 for supplying the second hard disk group 153. A second voltage is received by the third power input terminal 103, and is output from the third output terminal 107 for supplying the first hard disk group 151. The second voltage is also received by the fourth power input terminal 104, and is output from the fourth output terminal 108 for supplying the second hard disk group 153. In the embodiment, the first voltage and the second voltage are direct current (DC) voltages. The first voltage is 5V, and the second voltage is 12V, in one example.

The first switch circuit 160 is electronically coupled between the first power input terminal 101 and the second power input terminal 102. The first switch controller 180 switches on or switches off the first switch 160. When the first switch circuit 160 is switched on, the first power input terminal 101 is electronically coupled to the second power input terminal 102. When the first switch circuit 160 is switched off, the first power input terminal 101 is disconnected from the second power input terminal 102.

In detail, the first switch circuit 160 includes a first transistor. The first transistor includes a first terminal 161, a second terminal 162 and a controlling terminal 163. The first terminal 161 of the first transistor is electronically coupled to the first power input terminal 101, the second terminal 162 of the first transistor is electronically coupled to the second power input terminal 102, and the controlling terminal 163 of the first transistor is electronically coupled to the first switch controller 180. The first switch controller 180 includes a first jumping component 185. The first jumping component 185 includes a first pin 181, a second pin 182, a third pin 183 and a first jumper 184. The first pin 181 receives a first controlling voltage, the second pin 182 is electronically coupled to the controlling terminal 163 of the first transistor, and the third pin 183 receives a second controlling voltage. The first jumper 184 electronically couples the first pin 181 to the second pin 182, or electronically couples the second pin 182 to the third pin 183. When the first jumper 184 electronically couples the first pin 181 to the second pin 182, the first switch circuit 160 is switched on under the control of the first controlling voltage. When the first jumper 184 electronically couples the second pin 182 to the third pin 183, the first switch circuit 160 is switched off under the control of the second controlling voltage. In the embodiment, the first power input terminal 101 is also electronically coupled to the first pin 181, and the first voltage received by the first power input terminal 101 works as the first controlling voltage. The third pin 183 is grounded, and the second controlling voltage is zero volts.

The second switch circuit 170 is electronically coupled between the third power input terminal 103 and the fourth power input terminal 104. The second switch controller 190 controls the second switch circuit 170 to switch on or switch off. When the second switch circuit 170 is switched on, the third power input terminal 103 is electronically coupled to the fourth power input terminal 104. When the second switch circuit 170 is switched off, the third power input terminal 103 is disconnected from the fourth power input terminal 104.

In detail, the second switch circuit 170 includes a second transistor. The second transistor includes a first terminal 171, a second terminal 172 and a controlling terminal 173. The second switch controller 190 includes a second jumping component 195. The second jumping component 195 includes a fourth pin 191, a fifth pin 192, a sixth pin 193 and a second jumper 194. The first terminal 171 of the second transistor is electronically coupled to the third power input terminal 103. The second terminal 172 of the second transistor is electronically coupled to fourth power input terminal 104. The controlling terminal 173 of the second transistor is electronically coupled to the fifth pin 192. The fourth pin 191 is electronically coupled to the first power input terminal 101, and is configured to receive the first voltage as the first controlling voltage. The sixth pin 193 is grounded, and is configured to receive the second controlling voltage. In the embodiment, the second controlling voltage is zero volts. The second jumper 194 is configured to electronically couple the fourth pin 191 to the fifth pin 192 or electronically coupling the fifth pin 192 to the sixth pin 193. When the second jumper 194 electronically couples the fourth pin 191 to the fifth pin 192, the second switch circuit 170 is switched on under the control of the first controlling voltage. When the second jumper 194 electronically couples the fifth pin 192 to the sixth pin 193, the second switch circuit 170 is switched off under the control of the second controlling voltage.

In the embodiment, the first switch controller 180 further includes a first resistor 186. The first pin 181 receives the first controlling voltage via the first resistor 186. The second switch controller 190 further includes a second resistor 196. The fourth pin 191 receives the first controlling voltage via the second resistor 190. The first transistor and the second transistor are N-channel field-effect transistors.

The power supply circuit 100 is suitable for the service system 10 including two servers 11 and the service system 10 including only one server 11.

When two servers 11 are placed in the enclosure of the service system 10, the first hard disk group 151 and the second hard disk group 153 are controlled by the two servers 11 respectively, that is, the first hard disk group 151 is controlled by one server 11, and the second hard disk group 153 is controlled by the other server 11. The first hard disk group 151 and the second hard disk group 153 are supplied independently by the power supply circuit 100. Both of the first switch circuit 160 and the second switch circuit 170 are switched off, the first power input terminal 101 and the second power input terminal 102 receive the first voltage, and the third power input terminal 103 and the fourth power input terminal 104 receive the second voltage.

When only one server 11 is placed in the enclosure of the service system 10, both of the first hard disk group 151 and the second hard disk group 153 are controlled by the server 11. The first switch circuit 160 and the second switch circuit 170 are switched on, the first power input terminal 101 and the second power input terminal 102 receive the first voltage together, and the third power input terminal 103 and the fourth power input terminal 104 receive the second voltage together. When the first voltage is provided to at least one of the first power input terminal 101 and the second power input terminal 102, and the second voltage is provided to at least one of third power input terminal 103 and the fourth power input terminal 104, the first hard disk group 151 and the second hard disk group 153 are supplied with power.

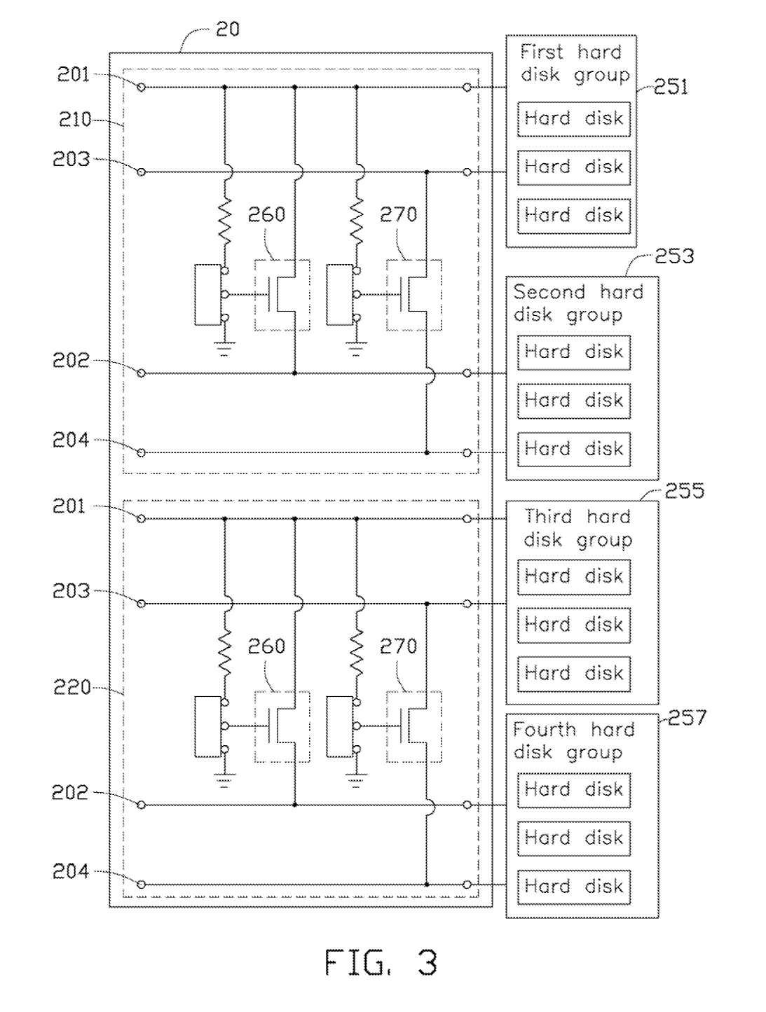

FIG. 3 is a circuit diagram of a hard disk backplane 20 powering the hard disk groups. The hard disk backplane 20 includes a first power supply circuit 210 and a second power supply circuit 220. The first power supply circuit 210 and the second power supply circuit 220 are on a printed circuit board (PCB) and are independent from each other. The hard disk backplane 14 is applied for the service system including four servers and four hard disk groups, that is, the service system includes four servers and twelve hard disks, and the twelve hard disks are divided into four groups, named first hard disk group 251, second hard disk group 253, third hard disk group 255 and fourth hard disk group 257. Each of the first hard disk group 251, the second hard disk group 252, the third hard disk group 253 and the fourth hard disk group 254 includes three hard disks.

Each of the first power supply circuit 210 and the second power supply circuit 220 has the same structure as the power supply circuit 100 in FIG. 2. Details of the structure of the first power supply circuit 210 and the second power supply circuit 220 are not described here. The first power supply circuit 210 supplies the first hard disk group 251 and the second hard disk group 253. The second power supply circuit 220 supplies the third hard disk group 255 and the fourth hard disk group 257.

When four servers are placed in the enclosure of the service system, each of the four servers electronically couples a first hard disk group 251, a second hard disk group 253, a third hard disk group 255 and a fourth hard disk group 257 respectively, and the first hard disk group 251, the second hard disk group 253, the third hard disk group 255 and the fourth hard disk group 257 are controlled by each of the four servers respectively. When both of a first switch circuit 260 and a second switch circuit 270 are switched off, a first power input terminal 201 and a second power input terminal 202 receive a first voltage, and a third power input terminal 203 and a fourth power input terminal 204 receive a second voltage. Each of the four servers controls the first hard disk group 251, the second hard disk group 253, the third hard disk group 255 and the fourth hard disk group 257 independently.

When two servers are placed in the enclosure of the service system, one of the two servers controls the first hard disk group 251 and the second hard disk group 253 together, and the other server controls the third hard disk group 255 and the fourth hard disk group 257 together. The controlling principle of one server controlling the first hard disk group 251 and the second hard disk group 253, and the controlling principle of the other servers controlling the third hard disk group 255 and the fourth hard disk group 257 are the same as the controlling principle of one server controlling the first hard disk group 151 and the second hard disk group 153 described above. Taking the first hard disk group 251 and the second hard disk group 253 controlled by one of the two servers as an example, the first switch circuit 260 and the second switch circuit 270 are switched on, the first power input terminal 201 and the second power input terminal 202 receive the first voltage together, and the third power input terminal 203 and the fourth power input terminal 204 receive the second voltage together. When the first voltage is provided to at least one of the power input terminal 201 and the second power input terminal 202, and the second voltage is provided to at least one of the third power input terminal 203 and the fourth power input terminal 204, the first hard disk group 251 and the second hard disk group 253 are thus supplied with power.

When three servers are placed in the enclosure of the service system, the first hard disk group 251 is controlled by a first server, the second hard disk group 253 is controlled by a second server, and the third hard disk group 255 and the fourth hard disk server 257 are controlled by a third server.

According to the above description, the hard disk backplane 20 is suitable for a service system including two servers, three servers, or four servers.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A power supply circuit, comprising:
a first power input terminal receiving a first voltage and outputting the first voltage to supply a first hard disk group;
a second power input terminal receiving the first voltage and outputting the first voltage to supply a second hard disk group;
a first switch circuit electronically coupled between the first power input terminal and a second power input terminal; and
a first switch controller configured to switch on or switch off the first switch circuit;
wherein when the first switch circuit is switched on, the first power input terminal is electronically connected to the second power input terminal, and when the first switch circuit is switched off, the first power input terminal is disconnected from the second power input terminal.

2. The power supply circuit according to claim 1, wherein the first switch circuit comprises a first transistor, where the first transistor comprises:
a first terminal electronically coupled to the first power input terminal;
a second terminal electronically coupled to the second power input terminal; and
a controlling terminal electronically coupled to the first switch controller.

3. The power supply circuit according to claim 2, wherein the first switch controller comprises a first jumping component, where the first jumping component comprises:
a first pin configured to receive a first controlling voltage;
a second pin electronically coupled to the controlling terminal of the first transistor;
a third pin configured to receive a second controlling voltage; and
a first jumper configured to electronically couple the first pin to the second pin, or electronically couple the second pin to the third pin;
when the first jumper is electronically coupled the first pin to the second pin, the first switch circuit is switched on by control of the first controlling voltage, and when the first jumper is electronically coupled the second pin to the third pin, the first switch circuit is switched off by control of the second controlling voltage.

4. The power supply circuit according to claim 3, wherein the first switch controller comprises a first resistor, where the first pin receives the first controlling voltage via the first resistor.

5. The power supply circuit according to claim 3, wherein the third pin is grounded, and the second controlling voltage is 0V.

6. The power supply circuit according to claim 5, wherein the first power input terminal is electronically coupled to the first pin, and the first voltage received by the first power input terminal is served as the first controlling voltage.

7. The power supply circuit according to claim 6, wherein the first voltage is 5V.

8. The power supply circuit according to claim 6, further comprising:
a third power input terminal receiving a second voltage and outputting the second voltage to supply the first hard disk group;
a fourth power input terminal receiving the second voltage and outputting the second voltage to supply the second hard disk group;
a second switch circuit electronically coupling between the third power input terminal and the fourth power input terminal; and
a second switch controller configured to switch on or switch off the second switch circuit;
when the second switch circuit is switched on, the third power input terminal is electronically connected to the fourth power input terminal, and when the second switch circuit is switched off, the third power input terminal is disconnected from the fourth power input terminal.

9. The power supply circuit according to claim 8, wherein the second switch circuit comprises a second transistor, wherein the second transistor comprises:
a first terminal electronically coupled to the third power input terminal;
a second terminal electronically coupled to the fourth power input terminal; and
a controlling terminal electronically coupled to the second switch controller.

10. The power supply circuit according to claim 9, wherein the second switch controller comprises a second jumping component, where the second jumping component comprises:
a fourth pin electronically coupled to the first power input terminal for receiving the first voltage;
a fifth pin electronically coupled to the controlling terminal of the second transistor;
a sixth pin being grounded and configured to receive the second controlling voltage; and
a second jumper configured to electronically couple the fourth pin to the fifth pin, or electronically couple the fifth pin to the sixth pin;
when the second jumper is electronically coupled the fourth pin to the fifth pin, the second switch circuit is switched on by controlling of the first controlling voltage, and when the second jumper is electronically coupled the fifth pin to the sixth pin, the second switch circuit is switched off by controlling of the second controlling voltage.

11. A hard disk backplane, comprising a power supply circuit for supplying a first hard disk driver group and a second hard disk group of a service system, wherein the power supply circuit comprises:
a first power input terminal receiving a first voltage and outputting the first voltage to supply the first hard disk group;
a second power input terminal receiving the first voltage and outputting the first voltage to supply the second hard disk group;
a first switch circuit electronically coupled between the first power input terminal and second power input terminal; and
a first switch controller configured to switch on or switch off the first switch circuit;
when the first switch circuit is switched on, the first power input terminal is electronically connected to the second power input terminal, and when the first switch circuit is switched off, the first power input terminal is disconnected from the second power input terminal.

12. The hard disk backplane according to claim 11, wherein the first switch circuit comprises a first transistor, where the first transistor comprises:
a first terminal electronically coupled to the first power input terminal;
a second terminal electronically coupled to the second power input terminal; and
a controlling terminal electronically coupled to the first switch controller.

13. The hard disk backplane according to claim 12, wherein the first switch controller comprises a first jumping component, where the first jumping component comprises:
a first pin configured to receive a first controlling voltage;
a second pin electronically coupled to the controlling terminal of the first transistor;
a third pin configured to receive a second controlling voltage; and
a first jumper configured to electronically couple the first pin to the second pin, or electronically couple the second pin to the third pin;
when the first jumper is electronically coupled the first pin to the second pin, the first switch circuit is switched on by control of the first controlling voltage, and when the first jumper is electronically coupled the second pin to the third pin, the first switch circuit is switched off by control of the second controlling voltage.

14. The hard disk backplane according to claim 13, wherein the first switch controller comprises a first resistor, where the first pin receives the first controlling voltage via the first resistor.

15. The hard disk backplane according to claim 13, wherein the third pin is grounded, and the second controlling voltage is 0V.

16. The hard disk backplane according to claim 15, wherein the first power input terminal is electronically coupled to the first pin, and the first voltage received by the first power input terminal is served as the first controlling voltage.

17. The hard disk backplane according to claim 16, wherein the first voltage is 5V.

18. The hard disk backplane according to claim 16, the power supply circuit further comprising:
a third power input terminal receiving a second voltage and outputting the second voltage to supply the first hard disk group;
a fourth power input terminal receiving the second voltage and outputting the second voltage to supply the second hard disk group;
a second switch circuit electronically coupling between the third power input terminal and the fourth power input terminal; and
a second switch controller configured to switch on or switch off the second switch circuit;
when the second switch circuit is switched on, the third power input terminal is electronically connected to the fourth power input terminal, and when the second switch circuit is switched off, the third power input terminal is disconnected from the fourth power input terminal.

19. The hard disk backplane according to claim 18, wherein the second switch circuit comprises a second transistor, wherein the second transistor comprises:
a first terminal electronically coupled to the third power input terminal;
a second terminal electronically coupled to the fourth power input terminal; and
a controlling terminal electronically coupled to the second switch controller.

20. The hard disk backplane according to claim 19, wherein the second switch controller comprises a second jumping component, where the second jumping component comprises:
a fourth pin electronically coupled to the first power input terminal for receiving the first voltage;
a fifth pin electronically coupled to the controlling terminal of the second transistor;
a sixth pin being grounded and configured to receive the second controlling voltage; and
a second jumper configured to electronically couple the fourth pin to the fifth pin, or electronically couple the fifth pin to the sixth pin;
when the second jumper is electronically coupled the fourth pin to the fifth pin, the second switch circuit is switched on by control of the first controlling voltage, and when the second jumper is electronically coupled the fifth pin to the sixth pin, the second switch circuit is switched off by control of the second controlling voltage.
